(19) United States
(12) Patent Application Publication
(10) Pub. No.: US 2019/0235315 A1
(43) Pub. Date: Aug. 1, 2019

(54) LIQUID CRYSTAL DISPLAY PANEL AND LIQUID CRYSTAL DISPLAY DEVICE

(71) Applicant: Huizhou China Star Optoelectronics Technology Co., Ltd., Huizhou City (CN)

(72) Inventor: Bo HAI, Huizhou City (CN)

(21) Appl. No.: 15/969,962

(22) Filed: May 3, 2018

Related U.S. Application Data
(63) Continuation of application No. PCT/CN2018/077096, filed on Feb. 24, 2018.

(30) Foreign Application Priority Data
Feb. 1, 2018 (CN) 201810106536.X

(51) Int. Cl. G02F 1/1335; G02F 1/017; G02B 5/30; B32B 27/08

(52) U.S. Cl. CPC G02F 1/133528; G02F 1/017; G02B 5/3025; C08L 1/12; G02F 2001/01791; C08L 2203/20; B32B 2457/202; B32B 27/08

(57) ABSTRACT

A liquid crystal display panel and a liquid crystal display device are provided. The liquid crystal display panel includes a polarizer, a first substrate, a liquid crystal layer, a second substrate and a quantum-dot polarizer, the polarizer comprising a first protective layer and a first polarizing layer, the quantum-dot polarizer comprising a second protective layer and a second polarizer, an absolute value of a difference between a thickness of the first protective layer and a thickness of the second protective layer is within a preset threshold range. According to the above method, the present disclosure can reduce the difference in thickness between the polarizer and the quantum-dot polarizer, so that the liquid crystal panel does not easily warp.

### CROSS-REFERENCE TO RELATED APPLICATIONS

This is a continuation of International Application PCT/CN2018/077096, with an international filing date of Feb. 24, 2018, which claims foreign priority of Chinese Patent Application No. 201810106536.X, filed on Feb. 1, 2017 in the State Intellectual Property Office of China, the contents of all of which are hereby incorporated by reference.

### TECHNICAL FIELD

The present disclosure generally relates to liquid crystal display technology, and in particular to a liquid crystal display panel and a liquid crystal display device.

### BACKGROUND

In recent years, novel display technology such as organic light-emitting diode electroluminescence, laser display, and Micro LED has developed rapidly. Under this background, liquid crystal screen is constantly being updated, and new technology is used to make up for its shortcoming. Quantum-dot material has become the most widely studied luminescent material in the 21st century due to its excellent properties such as high color purity and continuous spectral tenability.

The inventor of the present disclosure discovers during the long-term research and development process that in the prior art, when a glass substrate is not affected by an external force, the glass substrate itself is not prone to warping. The common structure of a liquid crystal panel is that an upper polarizer and a lower polarizer are respectively located on the two outer sides of the liquid crystal panel, and other materials are located on the inner side of the liquid crystal panel. The PVA layer of the polarizer is formed by stretching the polymer chain material, and the PVA layer is not water-resistant, and the molecular chain trends to shrink after the PVA layer is exposed to heat and moisture, resulting in the first polarizer and the second polarizer generate a certain stress, therefore, can cause warping of the liquid crystal panel. When the difference between the thickness of the first polarizer and the thickness of the second polarizer is larger, the stress difference between the first polarizer and the second polarizer is larger, which causes the liquid crystal panel easily to warp.

### SUMMARY

The technical problem mainly solved by the present disclosure is to provide a liquid crystal display panel and a liquid crystal display device, which can reduce the difference in the thickness of the polarizer and the quantum-dot polarizer, so that the liquid crystal panel does not easily warp.

In order to solve the technical problem mentioned above, one technical solution adopted by the present disclosure is: providing a liquid crystal display panel including a polarizer, a first substrate, a liquid crystal layer, a second substrate and a quantum-dot polarizer sequentially arranged from top to bottom, wherein the first substrate is opposite to the second substrate, and the liquid crystal layer is sandwiched between the first substrate and the second substrate, the polarizer includes a first protective layer and a first polarizing layer, the first polarizing layer is disposed at a side of the first substrate far away from the liquid crystal layer, the first protective layer is disposed at a side of the first polarizing layer far away from the first substrate, the quantum-dot polarizer includes a second protective layer and a second polarizer, the second polarizer is disposed at a side of the second substrate far away from the liquid crystal layer, and the second protective layer is disposed at a side of the second polarizing layer far away from the second substrate, an absolute value of a difference between a thickness of the first protective layer and a thickness of the second protective layer is within a preset threshold range, the second protective layer comprising a quantum-dot material and at least one of cellulose triacetate, polyethylene terephthalate, polymethyl methacrylate, cycloolefin polymer, polymeric material and acrylic, the quantum-dot material includes Group IIB-VIA semiconductor compounds.

In order to solve the technical problem mentioned above, another technical solution adopted by the present disclosure is: providing a liquid crystal display panel including a polarizer, a first substrate, a liquid crystal layer, a second substrate and a quantum-dot polarizer sequentially arranged from top to bottom, wherein the first substrate is opposite to the second substrate, and the liquid crystal layer is sandwiched between the first substrate and the second substrate, the polarizer includes a first protective layer and a first polarizing layer, the first polarizing layer is disposed at a side of the first substrate far away from the liquid crystal layer, the first protective layer is disposed at a side of the first polarizing layer far away from the first substrate, the quantum-dot polarizer includes a second protective layer and a second polarizer, the second polarizer is disposed at a side of the second substrate far away from the liquid crystal layer, and the second protective layer is disposed at a side of the second polarizing layer far away from the second substrate, an absolute value of a difference between a thickness of the first protective layer and a thickness of the second protective layer is within a preset threshold range.

In order to solve the technical problem mentioned above, another technical solution adopted by the present disclosure is: providing a liquid crystal display device including a liquid crystal display panel, the liquid crystal display panel includes a polarizer, a first substrate, a liquid crystal layer, a second substrate and a quantum-dot polarizer sequentially arranged from top to bottom, wherein the first substrate is opposite to the second substrate, and the liquid crystal layer is sandwiched between the first substrate and the second substrate, the polarizer includes a first protective layer and a first polarizing layer, the first polarizing layer is disposed at a side of the first substrate far away from the liquid crystal layer, the first protective layer is disposed at a side of the first polarizing layer far away from the first substrate, the quantum-dot polarizer includes a second protective layer and a second polarizer, the second polarizer is disposed at a side of the second substrate far away from the liquid crystal layer, and the second protective layer is disposed at a side of the second polarizing layer far away from the second substrate, an absolute value of a difference between a thickness of the first protective layer and a thickness of the second protective layer is within a preset threshold range.

The benefit effects of the present disclosure are: different from the prior art, the present disclosure provides a liquid crystal display panel including a polarizer, a first substrate, a liquid crystal layer, a second substrate and a quantum-dot polarizer sequentially arranged from top to bottom, the polarizer includes a first protective layer and a first polarizing layer, the first polarizing layer is disposed at a side of the first substrate far away from the liquid crystal layer, the first protective layer is disposed at a side of the first polarizing layer far away from the first substrate, the quantum-dot polarizer includes a second protective layer and a second polarizer, the second polarizer is disposed at a side of the second substrate far away from the liquid crystal layer, and the second protective layer is disposed at a side of the second polarizing layer far away from the second substrate, an absolute value of a difference between a thickness of the first protective layer and a thickness of the second protective layer is within a preset threshold range. In the above method, the present disclosure increases the water-resistant oxygen-resistant ability of the polarizer and the quantum-dot polarizer by arranging the first protective layer on the first polarizing layer and arranging the second protective layer on the second polarizing layer to prevent the polarizer from being deformed due to heat or water absorption, thereby preventing the liquid crystal panel from warping. At the same time, by controlling the difference between the thickness of the first protective layer and the thickness of the second protective layer, the present disclosure reduces the difference between the thickness of the polarizer and the thickness of the quantum-dot polarizer to reduce the difference between the stress of the polarizer and the stress of the quantum-dot polarizer in the high temperature and high humidity environment, thereby the liquid crystal panel does not easily warp.

### BRIEF DESCRIPTION OF THE DRAWINGS

In order to more clearly explain the technical solutions in the embodiments of the present disclosure, the drawings used in the description of the embodiments will be briefly described below. Obviously, the drawings in the following description are merely some embodiments of the present invention. For those of ordinary skill in the art, other drawings may also be obtained based on these drawings without any creative work. among them:

FIG. 1 is a schematic diagram of a liquid crystal display panel according to an embodiment of the present disclosure.

FIG. 2 is a schematic diagram of a liquid crystal display device according to an embodiment of the present disclosure.

### DETAILED DESCRIPTION

The technical solutions in the embodiments of the present disclosure will be clearly and completely described in connection with the drawings in the embodiments of the present disclosure. Obviously, the embodiments described here are merely parts of the present disclosure, not all parts. Based on the embodiments in the present disclosure, all other embodiments can be obtained by those skilled in the art without making any creative work are within the scope of the protection of the present disclosure.

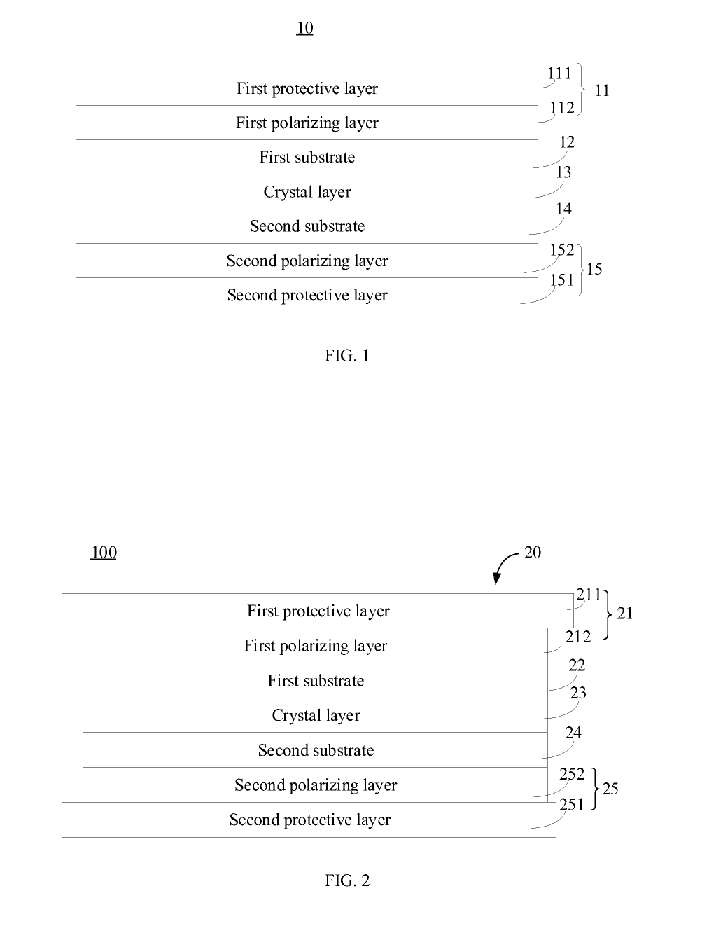

Referring to FIG. 1, FIG. 1 is a schematic diagram of a liquid crystal display panel according to an embodiment of the present disclosure. The liquid crystal display panel 10 includes a polarizer 11, a first substrate 12, a liquid crystal layer 13, a second substrate 14 and a quantum-dot polarizer 15 sequentially arranged from top to bottom.

The polarizer 11 includes a first protective layer 111 and a first polarizing layer 112. The first polarizing layer 112 is disposed at a side of the first substrate 12 far away from the liquid crystal layer 13, and the first protective layer 111 is disposed at a side of the first polarizing layer 112 far away from the first substrate 12.

Specifically, in the present embodiment, the polarizer 11 is a polarizer that does not contain a quantum-dot material. The first polarizing layer 112 may include at least one of a PVA layer, a compensation film, and a PSA layer. The first protective layer 111 may be a protective film layer having water resistance, oxygen resistance, or water and oxygen resistance. The first protective layer 111 is used to protect the first polarizing layer 112 so as to prevent the first polarizing layer 112 from being deformed due to moisture. Among them, the water-resistant protective film layer refers to a protective film layer that is resistant to water. The oxygen-resistant protective film layer refers to a protective film layer that is resistant to oxygen. The water-resistant oxygen-resistant protective film layer refers to a protective film layer that is resistant to both water and oxygen. The quantum-dot polarizer 15 includes a second protective layer 151 and a second polarizing layer 152. The second polarizing layer 152 is disposed at a side of the second substrate 14 far away from the liquid crystal layer 13, and the second protective layer 151 is disposed at a side of the second polarizing layer 152 far away from the second substrate 14.

Specifically, in the present embodiment, the quantum-dot polarizer 15 is a polarizer containing a quantum-dot material. The second polarizing layer 152 may include a PVA layer, a compensation film, and a PSA layer. The second protective layer 151 may be a protective film layer having water resistance, oxygen resistance, or water and oxygen resistance. The second protective layer 151 is used to protect the second polarizing layer 152 so as to prevent the second polarizing layer 152 from being deformed due to moisture.

The absolute value of the difference between the thickness of the first protective layer 111 and the thickness of the second protective layer 151 is within the preset threshold range.

Specifically, in the present embodiment, the absolute value of the difference between the thickness of the first protective layer 111 and the thickness of the second protective layer 151 is within a preset threshold range. Among them, the preset threshold can be set according to the needs of the user, and can also be the empirical value in the production process. The preset threshold range may be 0-500 μm, for example, the preset threshold may be 0 μm, 1 μm, 20 μm, 50 μm, 100 μm, 200 μm, 500 μm. Wherein, when the thickness of the first protective layer 111 is the same as the thickness of the second protective layer 151, the absolute value of the difference between the thickness of the first protective layer 111 and the thickness of the second protective layer 151 is 0 μm. By the above manner, in this embodiment, the first protective layer 111 is disposed at the first polarizing layer 112, and the second protective layer 151 is disposed at the second polarizing layer 152, thereby increasing the water-resistant oxygen-resistant ability of the polarizer and the quantum-dot polarizer to prevent the polarizer from being deformed due to the stress caused by heat or moisture, thereby preventing warping of the liquid crystal panel. Meanwhile, in this embodiment, by controlling the difference between the thickness of the first protective layer 111 and the thickness of the second protective layer 151, the difference between the thickness of the polarizer 11 and the thickness of the quantum-dot polarizer 15 is reduced, so as to reduce the difference between the stress of the polarizer 11 and the stress of the quantum-dot polarizer 15 generated in the high-temperature and high-humidity environment, thereby the liquid crystal panel does not easily warp.

In one embodiment, the first protective layer 111 includes at least one of tri-cellulose acetate (TCA), polyethylene terephthalate (PET), polymethyl methacrylate (PMMA) and cyclo-olefin polymer (COP). The second protective layer 151 includes a quantum-dot material and at least one of cellulose triacetate, polyethylene terephthalate, polymethyl methacrylate, cyclo-olefin polymer, polymeric material and acrylic. It should be noted that the first protective layer 111 and the second protective layer 151 respectively include at least one layer of the above materials other than the quantum dot material. In the present embodiment, when the material layer of the first protective layer 111 and the material layer of the second protective layer 151 are the same, the number of material layers of the first protective layer 111 and the number of material layers of the second protective layer 151 may be the same. So that the absolute value of the difference between the thickness of the first protective layer 111 and the thickness of the second protective layer 151 is within the preset threshold range. In other embodiments, considering that the thickness of different material layers may not be the same, when the material layers of the first protective layer 111 and the second protective layer 151 are not the same, the number of the material layers of the first protective layer 111 and the second protective layer 151 are different so that the absolute value of the difference between the thickness of the first protective layer 111 and the thickness of the second protective layer 151 is within a preset threshold range.

Specifically, in the present embodiment, the polymeric material is a high-molecular compound having high barrier to water or/and oxygen. For example, the polymeric material includes at least one of acrylic resin, epoxy resin, cycloolefin polymer, organosilane resin, fiber ester. The polymeric material may be cyclo-olefin polymer, organosilane-based resin.

The quantum-dot material includes at least one of water-resistant composition, oxygen-resistant composition, or water/oxygen-resistant composition and a Group IIB-VIA semiconductor compound.

The Group IIB-VIA semiconductor compound may be a binary compound, a ternary compound or a quaternary compound, may be at least one of CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, CdZnSeS, CdZnSeTe, CdZnSTe, CdHgSeS, CdHgSeTe, CdHgSTe, HgZnSeS, HgZnSeTe, HgZnSTe.

The water-resistant composition is a material that is resistant to water. For example, the water-resistant composition may be at least one of polyurethane, phenol resin, urea resin, epoxy resin, silicon oxide, and zinc oxide.

The oxygen-resistant composition is a material that is resistant to oxygen. For example, the oxygen-resistant composition may be at least one of alkylated monophenols, alkylthiomethylphenols, hydroquinones, alkylated hydroquinones, tocopherols, hydroxylated thiodiphenyl ethers, alkylene bisphenols, O-, N- and S-benzyl compounds, hydroxybenzylated malonates, aromatic hydroxybenzyl compounds, triazine compounds, benzylphosphonates, acylaminophenols, esters of [3-(3,5-di-tert-butyl-Esters of 4-hydroxyphenyl)] propionic acid with monohydric or polyhydric alcohols, esters of [3-(5-tert-butyl-4-hydroxy-3-methylphenyl)] propionic acid with monohydric or polyhydric alcohols, esters of [3-(3,5-dicyclohexyl-4-hydroxyphenyl)] propionic acid with monohydric or polyhydric alcohols, esters of 3,5-di-tert-butyl-4-hydroxyphenylacetic acid with monohydric or polyhydric alcohols, amides of [3-(3,5-di-tert-butyl-4-hydroxyphenyl)] propionic acid, ascorbic acid and amine antioxidants, 2,2′-thiodiethylenediamine[3-(3,5-di-tert-butyl-4-hydroxyphenyl)propionate], 1,3,5-trimethyl-2,4,6-tris(3,5-di-tert-butyl-4-hydroxybenzyl) benzene, C13-C15 alkyl esters of 3,5-bis(1,1-dimethylethyl)-4-hydroxy-phenylpropionic acid, 3-(3′,5′-di-tert-butyl-4′-hydroxyphenyl)stearyl propionate, 1,3,5-tris(4-tert-butyl-3-hydroxy-2,6-dimethylbenzyl)-1,3,5-triazine-2,4,6-(1H,3H,5H)-triketone, 2,2′-methylenebis(6-tert-butyl-4-methylphenol), 1,1-bis(2-methyl-4-hydroxy-5-tert-butylphenyl)butane, 1,1,3-tris(2′-methyl-4′-hydroxy-5′-tert-butylphenyl) butane, butylation reaction products of p-cresol and dicyclopentadiene, triethylene glycol-bis[3-(3-tert-butyl-4-hydroxy-5-methylphenyl)propionate], N,N′-hexamethylenebis[3-(3,5-di-tert-butyl-4-hydroxyphenyl)]propionamide, 2,2′-thiobis(6-tert-butyl-4-methylphenol), 2,2′-methylenebis[4-methyl-6-(1-methyl-cyclohexyl)phenol], 2,2′-methylenebis(6-nonyl-p-cresol).

The water/oxygen-resistant composition is a material that is resistant to both water and oxygen. For example, the water/oxygen-resistant composition may be polyurethane, phenolic resin, urea resin, epoxy resin, silicon oxide, zinc oxide Alkylated monophenols, alkylthiomethylphenols, hydroquinones, alkylated hydroquinones, tocopherols, hydroxylated thiodiphenyl ethers, alkylene bisphenols, O-, N- and S-benzyl compounds, hydroxybenzylated malonates, aromatic hydroxybenzyl compounds, triazine compounds, benzylphosphonates, acylaminophenols, esters of [3-(3,5-di-tert-butyl-4-hydroxyphenyl)] propionic acid with monohydric or polyhydric alcohols, esters of [3-(5-tert-butyl-4-hydroxy-3-methylphenyl)] propionic acid with monohydric or polyhydric alcohols, esters of [3-(3,5-dicyclohexyl-4-hydroxyphenyl)] propionic acid with monohydric or polyhydric alcohols, esters of 3,5-di-tert-butyl-4-hydroxyphenylacetic acid with monohydric or polyhydric alcohols, amides of [3-(3,5-di-tert-butyl-4-hydroxyphenyl)] propionic acid, ascorbic acid and amine antioxidants, 2,2′-thiodiethylenebis [3-(3,5-di-tert-butyl-4-hydroxyphenyl) propionate], 1,3,5-trimethyl-2,4,6-tris(3,5-di-tert Butyl-4-hydroxybenzyl) benzene, C13-C15 alkyl esters of 3,5-bis(1,1-dimethylethyl)-4-hydroxy-phenylpropionic acid, 3-(3′,5′-di-tert-butyl-4′-hydroxyphenyl)stearyl propionate, 1,3,5-tris(4-tert-butyl-3-hydroxy-2,6-dimethylbenzyl)-1,3,5-triazine-2,4,6-(1H,3H,5H)-triketone, 2,2′-methylenebis(6-tert-butyl-4-methylphenol), 1,1-bis(2-methyl-4-hydroxy-5-tert-butylphenyl)butane, 1,1,3-tris(2′-methyl-4′-hydroxy-5′-tert-butylphenyl) butane, butylation reaction products of p-cresol and dicyclopentadiene, triethylene glycol-bis[3-(3-tert-butyl-4-hydroxy-5-methylphenyl)propionate], N,N′-hexamethylenebis[3-(3,5-di-tert-butyl-4-hydroxyphenyl)]propionamide, 2,2′-thiobis(6-tert-butyl-4-methylphenol), 2,2′-methylenebis[4-methyl-6-(1-methyl-cyclohexyl)phenol], 2,2′-methylenebis(6-nonyl-p-cresol).

In one embodiment, the quantum-dot material includes at least one of a first quantum-dot water-resistant material and a second quantum-dot water-resistant material.

It should be noted that in this embodiment, the water resistance of the first quantum-dot water-resistant material is better than that of the second quantum-dot water-resistant material. In terms of water-resistant stability and attenuation performance of the excitation efficiency, the use effect of the first quantum-dot water-resistant material is the same as that of the conventional quantum-dot material and the water-repellent protective layer. After using the first quantum-dot water-resistant material, no additional water-repellent protective layer is needed.

Specifically, in the present embodiment, the first quantum-dot water-resistant material and the second quantum-dot water-resistant material may include at least one of the water-resistant compositions in the above embodiments and the Group IIB-VIA semiconductor compound, which will not be repeated here.

In one embodiment, the quantum-dot material includes at least one of a first quantum-dot oxygen-resistant material and a second quantum-dot oxygen-resistant material.

It should be noted that in the present embodiment, the oxygen resistance of the first quantum-dot oxygen-resistant material may be better than that of the second quantum-dot oxygen-resistant material. In terms of oxygen-resistant stability and attenuation performance of the excitation efficiency, the use effect of the first quantum-dot oxygen-resistant material is the same as that of the combination of the conventional quantum-dot material film and the oxygen barrier protective layer. After using the first quantum-dot oxygen-resistant material, no additional oxygen barrier protective layer is needed.

Specifically, in the present embodiment, the first quantum-dot oxygen-resistant material and the second quantum-dot oxygen-resistant material may include at least one of the oxygen-resistant composition in the above embodiments and the Group IIB-VIA semiconductor compound, which will not be repeated here.

In one embodiment, the quantum-dot material includes at least one of a first quantum-dot water-resistant oxygen-resistant material and a second quantum-dot water-resistant oxygen-resistant material.

It should be noted that in this embodiment, the water resistance and oxygen resistance of the first quantum-dot water-resistant oxygen-resistant material may be better than that of the second quantum-dot water-resistant oxygen-resistant material. In terms of water-resistant oxygen-resistant stability and attenuation performance of the excitation efficiency, the use effect of the first quantum-dot water-resistant oxygen-resistant material is the same as that of the combination of the conventional quantum-dot material film and the water and oxygen barrier protective layer. After using the first quantum-dot water-resistant oxygen-resistant material, no additional water and oxygen barrier protective layer is needed.

Specifically, in this embodiment, the first quantum-dot water-resistant oxygen-resistant material and the second quantum-dot water-resistant oxygen-resistant material may be at least one of the water/oxygen-resistant compositions in the above embodiment and the Group IIB-VIA semiconductor compounds, which will not be repeated here.

In the above manner, by selecting different materials as the first protective layer material and the second protective layer material in the present embodiment, the first protective layer and the second protective layer are controlled to have similar water resistance, oxygen resistance, or water and oxygen resistance. Thus, the polarizer and the quantum-dot polarizer have similar water resistance, oxygen resistance, or water and oxygen resistance, so as to reduce the difference between the stress of the polarizer and the stress of the quantum-dot polarizer generated in a high temperature and high humidity environment, thereby the liquid crystal panel does not easily warp.

Referring to FIG. 2, FIG. 2 is a schematic diagram of a liquid crystal display device according to an embodiment of the present disclosure. The liquid crystal display device 100 includes a liquid crystal display panel 20.

Among them, the liquid crystal display panel 20 includes a polarizer 21, a first substrate 22, a liquid crystal layer 23, a second substrate 24, and a quantum-dot polarizer 25, which are sequentially arranged from top to bottom. The polarizer 21 includes a first protective layer 211 and a first polarizing layer 212. The first polarizing layer 212 is disposed at a side of the first substrate 22 far away from the liquid crystal layer 23, and the first protective layer 211 is disposed at a side of the first polarizing layer 212 far away from the first substrate 22. The quantum-dot polarizer 25 includes a second protective layer 251 and a second polarizing layer 252. The second polarizing layer 252 is disposed at a side of the second substrate 24 far away from the liquid crystal layer 23, and the second protective layer 251 is disposed at a side of the second polarizing layer 252 far away from the second substrate 24.

The absolute value of the difference between the thickness of the first protective layer 211 and the thickness of the second protective layer 251 is within the preset threshold range. The preset threshold range may be 0-500 μm, for example, the preset threshold may be 0 μm, 1 μm, 20 μm, 50 μm, 100 μm, 200 μm, 500 μm.

For a detailed description of the structure of the liquid crystal display panel 20 of this embodiment, please refer to the embodiment of the liquid crystal display panel 10 described above, which will not be repeated here.

Through the above manner, in this embodiment, the first protective layer 211 is disposed at the first polarizing layer 212, and the second protective layer 251 is disposed at the second polarizing layer 252, thereby increasing the water-resistant ability and the oxygen-resistant ability of the quantum-dot polarizer so as to prevent the polarizer from being deformed due to heat or water absorption, thereby preventing the liquid crystal panel from warping. Meanwhile, in this embodiment, by controlling the difference between the thickness of the first protective layer 211 and the thickness of the second protective layer 251, the difference between the thickness of the polarizer 21 and the thickness of the quantum-dot polarizer 25 is reduced, so as to reduce the difference between the stress of the polarizer 21 and the stress of the quantum-dot polarizer 25 generated in a high temperature and high humidity environment, thereby the liquid crystal panel does not easily warp.

In one embodiment, the first protective layer 211 includes at least one of cellulose triacetate, polyethylene terephthalate, polymethyl methacrylate, and cycloolefin polymer. The second protective layer 251 includes at least one of cellulose triacetate, polyethylene terephthalate, cycloolefin polymer, polymethyl methacrylate, a polymeric material, a quantum-dot material, and acrylic.

For a detailed description of the first protective layer 211 and the second protective layer 251 in this embodiment, please refer to the embodiment of the liquid crystal display panel 20 described above, which will not be repeated here.

In one embodiment, the quantum-dot material includes at least one of a first quantum-dot water-resistant material and a second quantum-dot water-resistant material. The quantum-dot material includes at least one of a first quantum-dot oxygen-resistant material and a second quantum-dot oxygen-resistant material. The quantum-dot material includes at least one of a first quantum-dot water-resistant oxygen-resistant material and a second quantum-dot water-resistant oxygen-resistant material.

For a detailed description of the quantum-dot material of this embodiment, please refer to the above embodiment of the liquid crystal display panel 20, which will not be described herein.

The method of the present disclosure will be further described below by the specific examples. However, the present disclosure is not limited to the scope of the described embodiments. Any improvement that does not exceed the concept of the present disclosure falls within the protection scope of the present disclosure.

### Embodiment 1

The liquid crystal display panel includes a PET layer, a barrier layer, a PVA layer, a compensation film, a PSA layer, a first substrate, a liquid crystal layer, a second substrate, a PSA layer, a compensation film, a PVA layer, a PET layer, a barrier layer, a quantum-dot material layer, a barrier layer and a PET layer which are sequentially arranged from top to bottom.

### Embodiment 2

The liquid crystal display panel includes a PET layer, a PVA layer, a compensation film, a PSA layer, a first substrate, a liquid crystal layer, a second substrate, a PSA layer, a compensation film, a PVA layer, first quantum-dot water-resistant oxygen-resistant material layer which are sequentially arranged from top to bottom.

### Embodiment 3

The liquid crystal display panel includes a cycloolefin polymer layer, a PVA layer, a compensation film, a PSA layer, a first substrate, a liquid crystal layer, a second substrate, a PSA layer, a compensation film, a PVA layer, a first quantum-dot and first water-resistant oxygen-resistant material layer which are sequentially arranged from top to bottom.

### Embodiment 4

The liquid crystal display panel includes a TAC/PET/PMMA/PVA layer, a compensation film, a PSA layer, first substrate, a liquid crystal layer, a second substrate, a PSA layer, a compensation film, a PVA layer, a TAC layer or PET layer or PMMA layer which are sequentially arranged from top to bottom.

### Embodiment 5

The liquid crystal display panel includes a TAC layer or PET layer or PMMA layer, a PVA layer, a compensation film, a PSA layer, a first substrate, a liquid crystal layer, a second substrate, a PSA layer, a compensation film, a PVA layer, a cap layer, a quantum-dot water-resistant oxygen-resistant material layer which are sequentially arranged from top to bottom.

### Embodiment 6

The liquid crystal display panel includes a TAC layer or a PET layer or a PMMA layer, a PVA layer, a compensation film, a PSA layer, a first substrate, a liquid crystal layer, a second substrate, a PSA layer, a compensation film, a PVA layer, and a cap layer, a hybrid layer of first quantum-dot water-resistant oxygen-resistant material and a polymer substrate which are sequentially arranged from top to bottom.

### Embodiment 7

The liquid crystal display panel includes a TAC layer or a PET layer or a PMMA layer, a PVA layer, a compensation film, a PSA layer, a first substrate, a liquid crystal layer, a second substrate, a PSA layer, a compensation film, a PVA layer, a hybrid layer of second quantum-dot water-resistant oxygen-resistant material and a polymeric material which are sequentially arranged from top to bottom.

### Embodiment 8

The liquid crystal display panel includes a TAC layer or a PET layer or a PMMA layer, a PVA layer, a compensation film, a PSA layer, a first substrate, a liquid crystal layer, a second substrate, a PSA layer, a compensation film, a PVA layer, a hybrid layer of second quantum-dot oxygen-resistant material and the water-resistant composition, or a hybrid layer of second quantum-dot oxygen-resistant material and the water-resistant/oxygen-resistant composition which are sequentially arranged from top to bottom.

### Embodiment 9

The liquid crystal display panel includes a TAC layer or a PET layer or a PMMA layer, a PVA layer, a compensation film, a PSA layer, a first substrate, a liquid crystal layer, a second substrate, a PSA layer, a compensation film, a PVA layer, a hybrid layer of second quantum-dot water-resistant oxygen-resistant material and a water-resistant/oxygen-resistant composition which are sequentially arranged from top to bottom.

### Embodiment 10

The liquid crystal display panel includes a substrate, a barrier layer, a substrate, a barrier layer, a substrate, a PVA layer, a compensation film, a PSA layer, a first substrate, a liquid crystal layer, a second substrate, a PSA layer, a compensation layer, a PVA layer, a substrate, a barrier layer, a quantum-dot material layer, a barrier layer, and substrate which are sequentially arranged from top to bottom.

### Embodiment 11

The liquid crystal display panel includes a substrate, a barrier layer, a substrate, a PVA layer, a compensation film, a PSA layer, a first substrate, a liquid crystal layer, a second substrate, a PSA layer, a compensation film, a PVA layer, a quantum-dot material layer, a barrier layer, and substrate which are sequentially arranged from top to bottom.

### Embodiment 12

The liquid crystal display panel includes a substrate, a PVA layer, a compensation film, a PSA layer, a first substrate, a liquid crystal layer, a second substrate, a PSA layer, a compensation film, a PVA layer, a polymer substrate and quantum-dot layer, a barrier layer, and substrate which are sequentially arranged from top to bottom. The thickness of the substrate is the same as the thickness of all the layers outside the PVA layer in the second polarizing layer.

It should be noted that, for detailed description of each material layer in the above described Embodiments 1-12, please refer to the above embodiment of the liquid crystal display panel 10, which will not be repeated here.

The above description depicts merely some exemplary embodiments of the disclosure, but is meant to limit the scope of the disclosure. Any equivalent structure or flow transformations made by the description and the drawing of the present disclosure, or any direct or indirect applications of the disclosure on other related fields, shall all be covered within the protection of the disclosure.

1. A liquid crystal display panel, comprising:
a polarizer, a first substrate, a liquid crystal layer, a second substrate, and a quantum-dot polarizer,
wherein the liquid crystal layer is sandwiched between the first substrate and the second substrate,
wherein the polarizer comprises a first protective layer and a first polarizing layer, the first polarizing layer being disposed on the first substrate, the first protective layer being disposed on the first polarizing layer so that the first substrate is sandwiched between the liquid crystal layer and the first polarizing layer, and the first polarizing layer is sandwiched between the first protective layer and the first substrate,
wherein the quantum-dot polarizer comprises a second protective layer and a second polarizing layer, the second polarizing layer being disposed on the second substrate, the second protective layer being disposed on the second polarizing layer, so that the second substrate is sandwiched between the liquid crystal layer and the second polarizing layer, and the second polarizing layer is sandwiched between the second protective layer and the second substrate,
wherein the second protective layer comprises a quantum-dot material comprising Group semiconductor compounds and at least one of polyethylene terephthalate, polymethyl methacrylate, and cyclo-olefin polymer, and is in direct contact with the second polarizing layer, and
wherein a thickness difference between the first protective layer and the second protective layer is within a preset threshold range.

2. The liquid crystal display panel according to claim 1, wherein the preset threshold range is 0-500 μm.

3. The liquid crystal display panel according to claim 1, wherein the first protective layer comprises at least one of cellulose triacetate, polyethylene terephthalate, polymethyl methacrylate, and cycloolefin polymer.

4. The liquid crystal display panel according to claim 1, wherein the quantum-dot material further comprises at least one of a first quantum-dot water-resistant material and a second quantum-dot water-resistant material, and a degree of water resistance of the first quantum-dot water-resistant material is higher than that of the second quantum-dot water-resistant material.

5. The liquid crystal display panel according to claim 1, wherein the quantum-dot material comprises at least one of a first quantum-dot oxygen-resistant material and a second quantum-dot oxygen-resistant material, and a degree of oxygen resistance of the first quantum-dot oxygen-resistant material is higher than that of the second quantum-dot oxygen-resistant material.

6. The liquid crystal display panel according to claim 1, wherein the quantum-dot material further comprises at least one of a first quantum-dot water-resistant oxygen-resistant material and a second quantum-dot water-resistant oxygen-resistant material, and a degree of water and oxygen resistance of the first quantum-dot water-resistant oxygen-resistant material is higher than that of the second quantum-dot water-resistant oxygen-resistant material.

7. A liquid crystal display panel, comprising a polarizer, a first substrate, a liquid crystal layer, a second substrate, and a quantum-dot polarizer,
wherein the liquid crystal layer is sandwiched between the first substrate and the second substrate,
wherein the polarizer comprises a first protective layer and a first polarizing layer, the first polarizing layer being disposed on the first substrate, the first protective layer being disposed on the first polarizing layer so that the first substrate is sandwiched between the liquid crystal layer and the first polarizing layer, and the first polarizing layer is sandwiched between the first protective layer and the first substrate,
wherein the quantum-dot polarizer comprises a second protective layer and a second polarizer, the second polarizer being disposed on the second substrate, the second protective layer being disposed on the second polarizing layer, so that the second substrate is sandwiched between the liquid crystal layer and the second polarizing layer, and the second polarizing layer is sandwiched between the second protective layer and the second substrate,
wherein a thickness difference between the first protective layer and the second protective layer is within a preset threshold range,
the preset threshold range is 0-500 μm.

8. The liquid crystal display panel according to claim 7, wherein the first protective layer comprises at least one of cellulose triacetate, polyethylene terephthalate, polymethyl methacrylate, and cycloolefin polymer.

9. The liquid crystal display panel according to claim 7, wherein the second protective layer comprises a quantum-dot material and at least one of polyethylene terephthalate, polymethyl methacrylate, cycloolefin polymer, polymeric material and acrylic.

10. The liquid crystal display panel according to claim 9, wherein the quantum-dot material comprises at least one of a first quantum-dot water-resistant material and a second quantum-dot water-resistant material, and a degree of water resistance of the first quantum-dot water-resistant material is higher than that of the second quantum-dot water-resistant material.

11. The liquid crystal display panel according to claim 9, wherein the quantum-dot material comprises at least one of a first quantum-dot oxygen-resistant material and a second quantum-dot oxygen-resistant material, and a degree of oxygen resistance of the first quantum-dot oxygen-resistant material is higher than that of the second quantum-dot oxygen-resistant material.

12. The liquid crystal display panel according to claim 9, wherein the quantum-dot material comprises at least one of a first quantum-dot water-resistant oxygen-resistant material and a second quantum-dot water-resistant oxygen-resistant material, and a degree of water and oxygen resistance of the first quantum-dot water-resistant oxygen-resistant material is higher than that of the second quantum-dot water-resistant oxygen-resistant material.

13. The liquid crystal display panel according to claim 9, wherein the quantum-dot material comprises Group IIB-VIA semiconductor compounds.

14. A liquid crystal display device, comprising a liquid crystal display panel, wherein the liquid crystal display panel comprises a polarizer, a first substrate, a liquid crystal layer, a second substrate, and a quantum-dot polarizer,
wherein the liquid crystal layer is sandwiched between the first substrate and the second substrate,
wherein the polarizer comprises a first protective layer and a first polarizing layer, the first polarizing layer being disposed on the first substrate, the first protective layer being disposed on the first polarizing layer so that the first substrate is sandwiched between the liquid crystal layer and the first polarizing layer, and the first polarizing layer is sandwiched between the first protective layer and the first substrate,
wherein the quantum-dot polarizer comprises a second protective layer and a second polarizer, the second polarizer being disposed on the second substrate, the second protective layer being disposed on the second polarizing layer, so that the second substrate is sandwiched between the liquid crystal layer and the second polarizing layer, and the second polarizing layer is sandwiched between the second protective layer and the second substrate,
wherein a thickness difference between the first protective layer and the second protective layer is within a preset threshold range,
the preset threshold range is 0-500 μm.

15. The liquid crystal display device according to claim 14, wherein the first protective layer comprises at least one of cellulose triacetate, polyethylene terephthalate, polymethyl methacrylate, and cycloolefin polymer.

16. The liquid crystal display device according to claim 14, wherein the second protective layer comprises a quantum-dot material and at least one of polyethylene terephthalate, polymethyl methacrylate, cycloolefin polymer, polymeric material and acrylic.

17. The liquid crystal display device according to claim 16, wherein the quantum-dot material further comprises at least one of a first quantum-dot water-resistant material and a second quantum-dot water-resistant material, and a degree of water resistance of the first quantum-dot water-resistant material is higher than that of the second quantum-dot water-resistant material.

18. The liquid crystal display device according to claim 16, wherein the quantum-dot material comprises at least one of a first quantum-dot oxygen-resistant material and a second quantum-dot oxygen-resistant material, and a degree of oxygen resistance of the first quantum-dot oxygen-resistant material is higher than that of the second quantum-dot oxygen-resistant material.

19. The liquid crystal display device according to claim 16, wherein the quantum-dot material further comprises at least one of a first quantum-dot water-resistant oxygen-resistant material and a second quantum-dot water-resistant oxygen-resistant material, and a degree of water and oxygen resistance of the first quantum-dot water-resistant oxygen-resistant material is higher than that of the second quantum-dot water-resistant oxygen-resistant material.

20. The liquid crystal display device according to claim 16, wherein the quantum-dot material comprises Group IIB-VIA semiconductor compounds.
